(19) United States
(12) Patent Application Publication
(10) Pub. No.: US 2005/0177715 A1
(43) Pub. Date: Aug. 11, 2005

(54) Method and system for managing identities in a peer-to-peer networking environment

(75) Inventors: Grigori M. Somin, Seattle, WA (US); Rohit Gupta, Redmond, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/775,916

(22) Filed: Feb. 9, 2004

(51) Int. Cl. H04L 9/00

(52) U.S. Cl. 713/156

(57) ABSTRACT

Disclosed is a system for organizing and storing information about multiple peer identities. New certificates are introduced that enable a user to efficiently create, modify, and delete identities and groups. New storage structures enable the user to list and search through existing identities, groups, and their related certificates. An identity certificate contains information about a peer identity. A group root certificate is created by a user when he decides to create a new group. When the group creator user wishes to invite another entity to join the group, it creates another type of certificate called a group membership certificate. The group membership certificate is logically “chained” to the group root certificate. The invitee checks the validity of these certificates by checking that the chaining has been properly done. The invitee may then be allowed to invite other entities to join the group by sending out its own group membership certificates.

### TECHNICAL FIELD

The present invention is related generally to identities in a peer-to-peer networking environment and, more particularly, to storing and managing peer and group identities.

### BACKGROUND OF THE INVENTION

Most communications depend upon the ability of one communicating “entity” to establish a connection with another, selected entity. These “entities” may be, for example, humans, computing devices, applications, or groups formed of any or all of these. In general, several issues need to be resolved before the entities can freely communicate. Before beginning to communicate, an entity first needs to discover how to direct its communications so that they reach the selected other entity (“the addressing issue”). Second, if the communications are to be secure, each entity would like to verify that the entity with which it is communicating really is the entity that it purports to be (“the identity verification issue”). Third, in some scenarios a first communicating entity wishes to use the verification that it has already established with a second entity as a basis for secure communications with a third entity (“the trust extension issue”).

These three issues are by no means new to the art of communications and indeed are illustrated (in Exodus chapters 3 and 4) in Moses' encounter with the burning bush. In that encounter, the addressing issue is resolved when Moses receives a name with which he can communicate (“I am that I am”). The identity verification issue is resolved by signs that prove to Moses the identity of the owner of the voice in the burning bush (the bush burns but is not consumed, Moses' staff turns into a snake, turns back into a staff, Moses' hand turns leprous, and is restored). Finally, Moses applies the principle of trust extension when he repeats these signs to prove to the elders of his people the nature of his previous communication.

Moving forward in time to the computer era, these communications issues have repeatedly been addressed by means of centralized, trusted authorities. Communicating entities look to those authorities as fonts of trusted information. As one example, the Internet Assigned Numbers Authority keeps official records of important numbers, such as Internetwork Protocol addresses. The well known Domain Name Service is an example of a single, though distributed, authority for addressing in the Internet world.

However, such centralization is not appropriate to the growing area of peer-to-peer (“P2P”) networking. Here, entities communicate with one another and create and join ad hoc groups without the burden of having to first set up and secure (and then later to depend upon) a centralized authority. Of course, the lack of a central authority means that the communications issues of identity verification and trust extension need to be resolved in a new way. Also, because most P2P networks are based on wireless communications in which devices constantly come into radio range and depart and often change their addresses as they move, the addressing issue also needs to be resolved anew.

Some aspects of these three communications issues have been resolved by means of certificate-based verification systems. Certificates bring together various pieces of information needed by a communicating entity. For example, U.S. patent application Ser. No. 09/956,260, “Peer-to-Peer Name Resolution Protocol (PNRP) Security Infrastructure and Method,” filed on Sep. 19, 2001, and incorporated herein by reference in its entirety, describes how a communicating entity creates a certificate containing the entity's friendly name and information useful in resolving that name to its current address. Well known public/private encryption key pairs are used to ensure the legitimacy of the certificates and thus to secure communications. As another example, U.S. patent application Ser. No. 09/955,924, “Peer-to-Peer Name Resolution Protocol (PNRP) Group Security Infrastructure and Method,” filed on Sep. 19, 2001, and incorporated herein by reference in its entirety, describes group certificates that are issued by the creator of a group. Only those entities that have legitimate group certificates may participate in the group. The group creator can extend his trust by issuing group certificates that allow recipients to issue further group certificates inviting other entities to join the group.

Although it is recommended that a user create only one identity for himself, some users choose to use these certificate services to create multiple communicating identities, each identity serving in a different communications role. Each identity may require access to a unique set of certificates. As a first step in holding off the possible resultant chaos, the user can implement a consistent management method such as that described in U.S. Patent Application 10/309,864, “Peer-to-Peer Identity Management Interfaces and Methods,” filed on Dec. 4, 2002, and incorporated herein by reference in its entirety. However, even that application does not describe how the user can manage a host of identities and their certificates in order to, for example, effectively resolve the communications issues of addressing, identity verification, and trust extension.

### SUMMARY OF THE INVENTION

In view of the foregoing, the present invention provides a system for organizing and storing information about multiple peer identities. New certificates are introduced that enable a user to efficiently create, modify, and delete identities and groups. New storage structures enable the user to list and search through existing identities, groups, and their related certificates. In some embodiments, all of the new certificates are implemented as special instances of X.509 public key infrastructure certificates, thus allowing the use of routines already developed to handle those certificates. All of the X.509 certificate fields can then be readily used such as, for example, the X.509 period of validity for the certificate.

An identity certificate contains information about a peer identity, including its public key and its peer name. In some embodiments, the peer name is chosen so as to be globally unique. (For example, a hash of the unique public key can be used to derive a unique peer name.) This globally unique peer name can then be used as a key when storing this certificate and all related certificates. The private key corresponding to the identity's public key can be safely stored in a secure location, for example by using Microsoft's Cryptographic Service Provider interface. The identity certificate is signed with that private key.

The present invention supports peer groups with two types of certificates. A group root certificate is created by a user when he decides to create a new group. The group can be given a globally unique name and, if so, that name can be used as a key for storing certificates related to the group. The group root certificate is signed with a private key known only to the group creator. When the group creator user wishes to invite another entity to join the group, it creates another type of certificate called a group membership certificate. The group membership certificate is logically “chained” to the group root certificate. Copies of the group root certificate (which do not contain the group private key) and the group membership certificate are sent to the invitee entity. The invitee checks the validity of these certificates by checking that the chaining has been properly done. The invitee may then be allowed to invite other entities to join the group by sending out its own group membership certificates.

As mentioned above, the structure of the new certificates is such that the identity peer names and the group names can be used as keys for storing related certificates. This allows the user to efficiently list and manipulate all related certificates.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram of a peer-to-peer networking environment with several peer computing devices and with two overlapping groups;

FIG. 2 is a schematic diagram generally illustrating an exemplary computer system that supports the present invention;

FIG. 3 is a flowchart of an exemplary procedure according to the present invention for creating a peer identity;

FIG. 4 is a data structure diagram including an exemplary identity certificate;

FIG. 5 is a block diagram of an identity certificate store;

FIG. 6 is a flowchart of an exemplary procedure for creating a peer group;

FIG. 7 is a data structure diagram including a group root certificate;

FIG. 8 is a flowchart of an exemplary procedure for creating a group membership certificate;

FIG. 9 is a data structure diagram including a group membership certificate;

FIG. 10 is a block diagram of a group identity certificate store; and

FIGS. 11a, 11b, and 11c together form a flowchart of an exemplary procedure for an invitee to a group to check the validity of the invitation.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

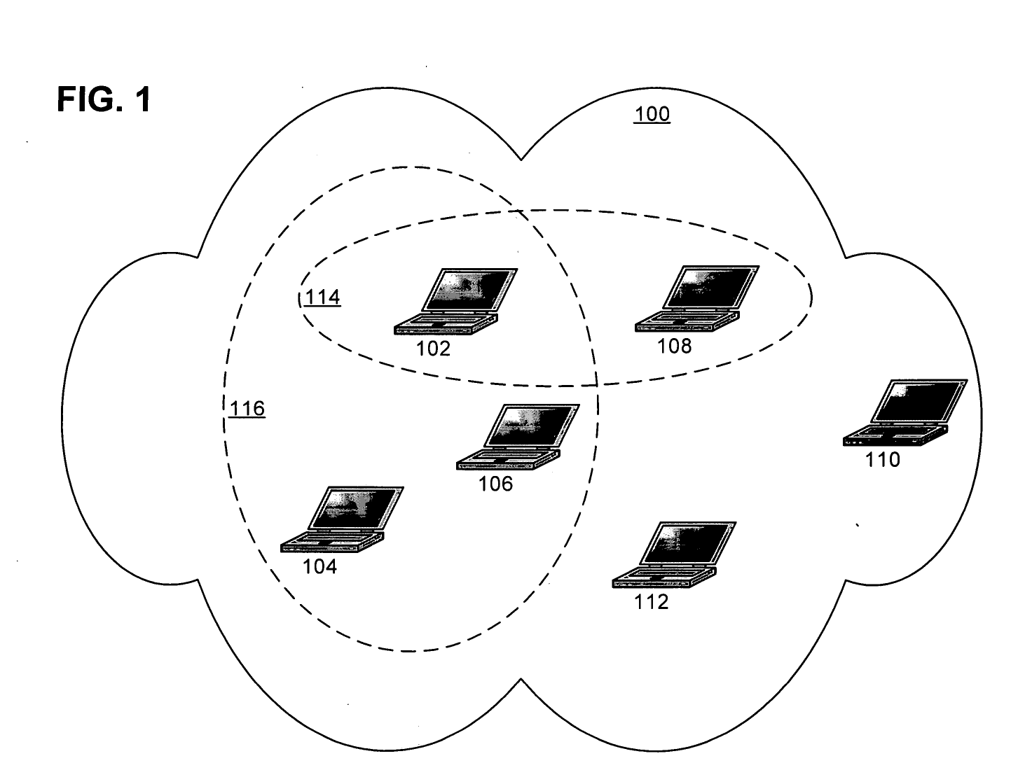

The present invention provides a system for organizing and manipulating information about a peer device's multiple identities. FIG. 1 illustrates the usefulness of such a system within a peer networking environment 100. The details of the communications technologies used are not of interest here; suffice it to say that the peer computing devices 102, 104, 106, 108, 110, and 112 in the peer networking environment 100 can, at least sometimes, communicate with one another. The “at least sometimes” caveat comes from a fundamental feature of peer-to-peer networking: Peer devices are constantly entering, leaving, and moving around the peer networking environment 100. To establish communications, peer devices track one another, noting arrivals and departures. Making this tracking task more interesting, the physical addresses and other important communications parameters of the peer devices change as the peers move. Note that FIG. 1 does not depict a central server keeping track of the wanderings of the peer devices and providing updated communications information to the peers. Upon the peer devices themselves lies the responsibility for gathering current information and for keeping that information up-to-date.

Also subject to constant change in the peer networking environment 100 are the identities used by the peer devices. Some of these identities represent peer devices while others represent, for example, applications and groups of peers. In the scenario of FIG. 1, an identity was created to represent the communications group 114 which contains the peer devices 102 and 108. Another identity represents another group 116, which is formed from the peer devices 102, 104, and 106. The peer device 102, which is in both groups 114 and 116, can choose to create a separate identity to represent its role in each group. With peer devices coming and going, with new groups being formed to serve specific communicative purposes, and with a given peer device creating multiple identities to represent its multiple roles in this dynamic environment, the need for an identity management becomes compelling.

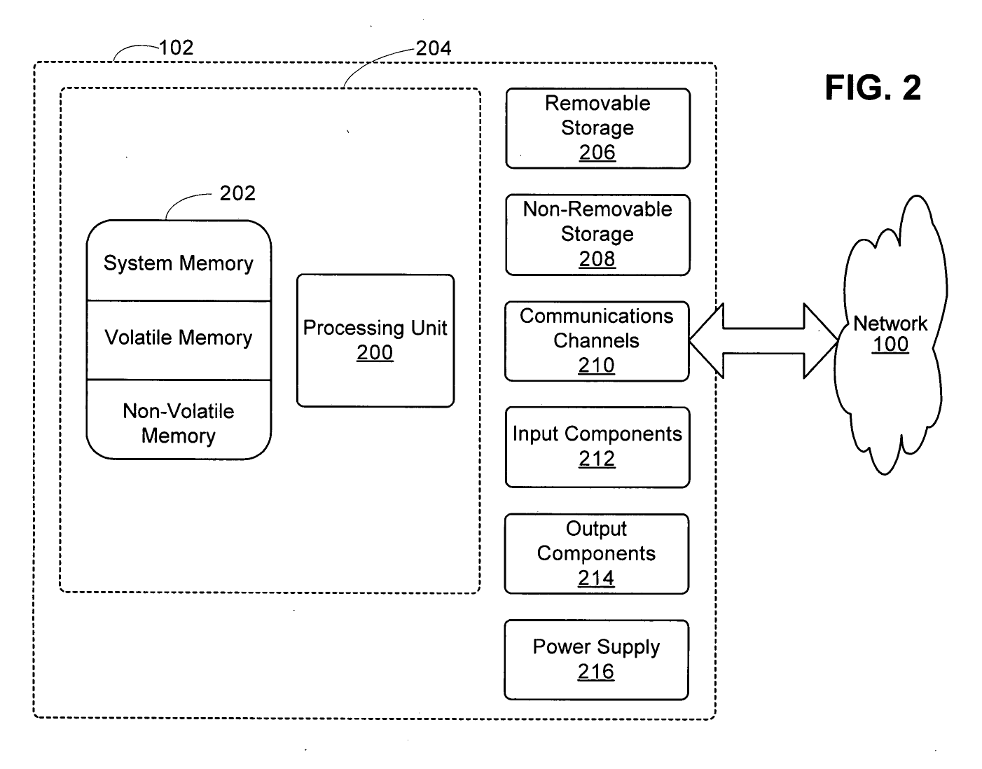

The peer device 102 of FIG. 1 may be of any architecture. FIG. 2 is a block diagram generally illustrating an exemplary computer system that supports the present invention. The computer system of FIG. 2 is only one example of a suitable environment and is not intended to suggest any limitation as to the scope of use or functionality of the invention. Neither should the peer device 102 be interpreted as having any dependency or requirement relating to any one or combination of components illustrated in FIG. 2. The invention is operational with numerous other general-purpose or special-purpose computing environments or configurations. Examples of well known computing systems, environments, and configurations suitable for use with the invention include, but are not limited to, personal computers, servers, hand-held or laptop devices, tablet devices, multiprocessor systems, microprocessor-based systems, set-top boxes, programmable consumer electronics, network PCs, minicomputers, mainframe computers, and distributed computing environments that include any of the above systems or devices. In its most basic configuration, the peer device 102 typically includes at least one processing unit 200 and memory 202. The memory 202 may be volatile (such as RAM), non-volatile (such as ROM or flash memory), or some combination of the two. This most basic configuration is illustrated in FIG. 2 by the dashed line 204. The peer device 102 may have additional features and functionality. For example, the peer device 102 may include additional storage (removable and non-removable) including, but not limited to, magnetic and optical disks and tape. Such additional storage is illustrated in FIG. 2 by removable storage 206 and by non-removable storage 208. Computer-storage media include volatile and non-volatile, removable and non-removable media implemented in any method or technology for storage of information such as computer-readable instructions, data structures, program modules, or other data. Memory 202, removable storage 206, and non-removable storage 208 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the peer device 102. Any such computer-storage media may be part of the peer 102. The peer 102 may also contain communications channels 210 that allow the peer 102 to communicate with other devices. Communications channels 210 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as wired networks and direct-wired connections, and wireless media such as acoustic, RF, infrared, and other wireless media. The term “computer-readable media” as used herein includes both storage media and communications media. The peer device 102 may also have input devices 212 such as a keyboard, mouse, pen, voice-input device, tablet, touch-input device, etc. Output devices 214 such as a display (which may be integrated with a touch-input device), speakers, and printer may also be included. All these devices are well known in the art and need not be discussed at length here.

The system of the present invention is based upon a number of new certificate types. These certificates gather together information useful in storing and managing a peer's identities. Once these certificates are described individually, the present discussion proceeds to their interrelationships and use.

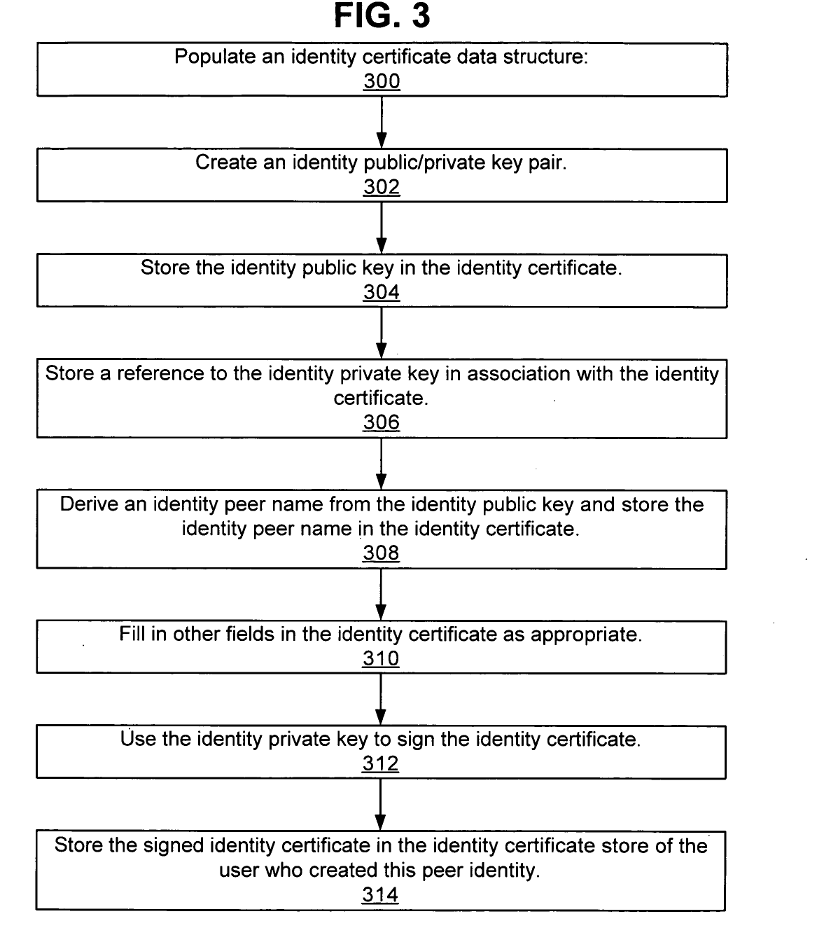

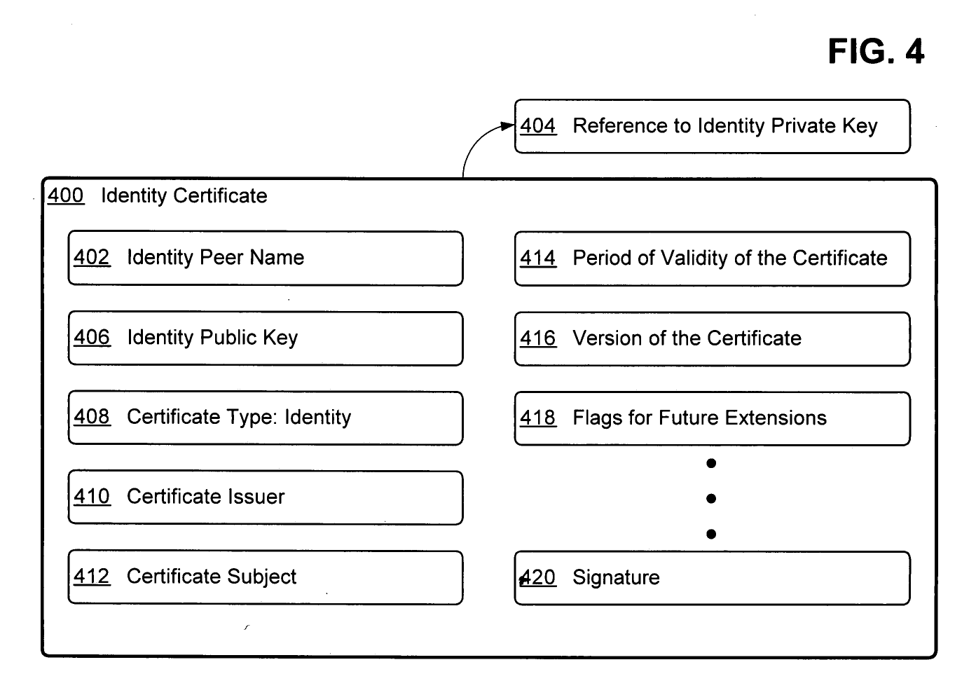

The first of the certificates represents an identity of a device, user, or application. FIG. 3 presents an exemplary method usable by the peer device 102 for creating this identity certificate, while FIG. 4 shows one embodiment of the structure of the certificate.

Beginning in step 300 of FIG. 3, an identity certificate data structure is populated. This certificate can be an X.509 certificate (designed for use in the public key infrastructure), but need not be. If an X.509 certificate is used, then existing code can be co-opted to implement some of the following steps.

In the remainder of the method of FIG. 3, the fields of this identity certificate (400 in FIG. 4) are populated. A unique public/private encryption key pair is created in step 302 using any of a number of techniques known in the art. This key pair can be generated locally on the peer device 102. The public key of the pair is stored in the identity certificate (field 406 of FIG. 4) in step 304. Unlike the public key, the private key of the pair should be kept by the peer device 102 as a closely guarded secret. To facilitate this, the private key is not kept in the identity certificate 400 itself, but rather a reference to it is stored in association with the identity certificate 400 (step 306, field 404). Systems for securely storing private keys are known in the art. For example, the private key can be stored in a secure container provided by Microsoft's Cryptographic Service Provider interface.

An identity peer name is derived from the public key in step 308 and is stored in field 402 of FIG. 4. One method of deriving the identity peer name is illustrated in U.S. Patent Application “Peer-to-Peer Name Resolution Protocol (PNRP) Group Security Infrastructure and Method,” referenced above. There, the identity peer name is a hash of the public key. In some embodiments, a “classifier” string is appended to the hash to form the identity peer name. As the public key is unique, this derivation method comes close to guaranteeing that the identity peer name is also unique. If the name turns out not to be unique, then the classifier string can be added or modified to achieve uniqueness. Other methods known in the art can be used to generate a unique identity peer name.

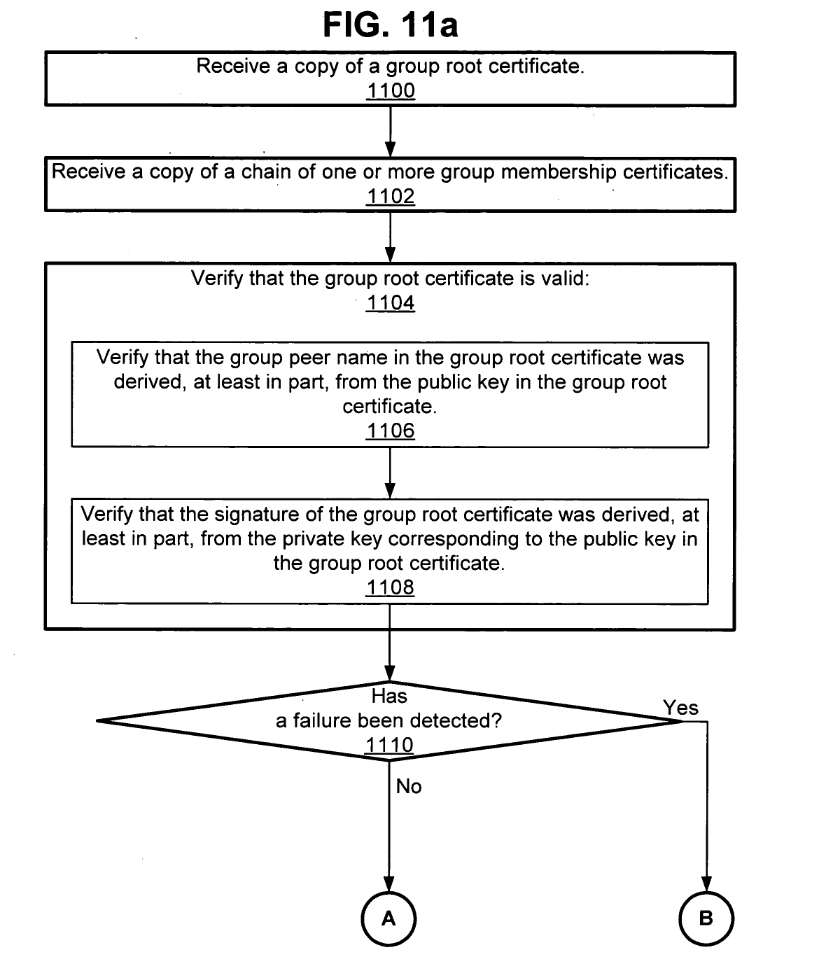

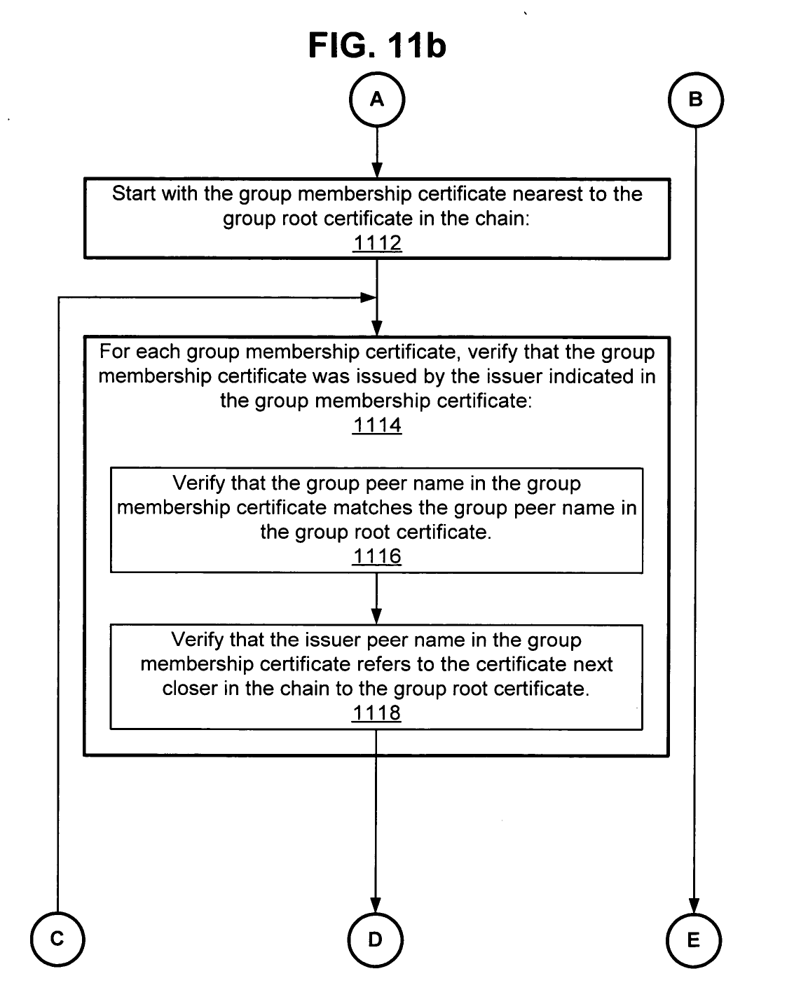

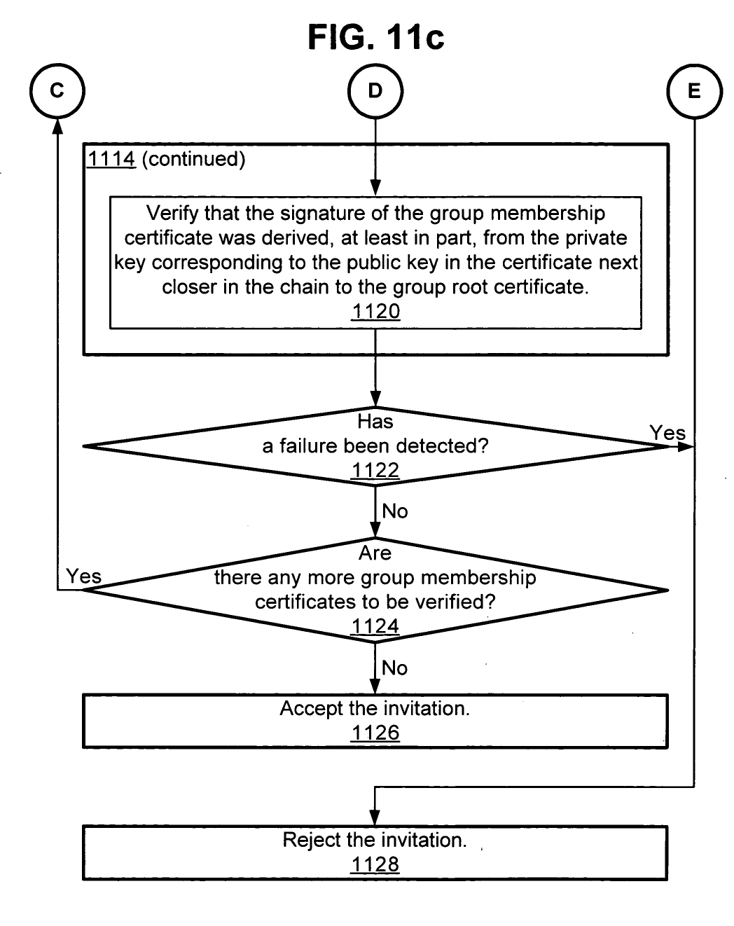

Other fields of the identity certificate 400 are populated in step 310. For example, field 408 of FIG. 4 indicates that this is an identity certificate rather than some other type. Fields 410 and 412, the certificate issuer and subject fields, respectively, both hold the name of the user at whose request this peer identity is created. To prevent this certificate 400 from outliving its usefulness, a period of validity is set in field 414. Any peer device receiving a copy of this certificate 400 (see the discussion below accompanying FIGS. 11a, 11b, and 11c) after the period of validity has expired will discard the certificate. If the certificate 400 is an X.509 certificate, then others of the fields defined by X.509 can be populated as appropriate.

Finally, in step 312 the private key is used to sign the certificate 400. Signing is a well known security technique: Simply put, any device that has access only to the public key of a public/private key pair can verify that the certificate 400 was signed by, and thus that the contents of the certificate 400 remain as written by, a device that has access to the private key. Here, because only the peer device 102 has access to that private key, a recipient of a copy of the identity certificate 400 can use the public key (field 406 of FIG. 4) to verify the signature (field 420) and know that the contents of the certificate 400 have not been altered since the time they were signed by the peer device 102. The discussion of FIGS. 11a, 11b, and 11c below provides examples of the use of signatures to validate certificates.

The present discussion does not cover how the peer device 102 uses the identity represented by the identity certificate 400 when communicating with its peers. For a presentation of that topic, see U.S. Patent Application “Peer-to-Peer Name Resolution Protocol (PNRP) Group Security Infrastructure and Method,” referenced above.

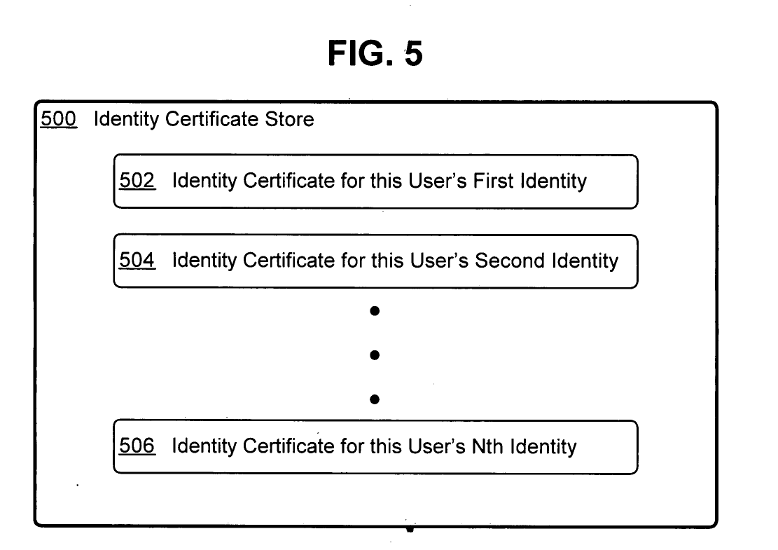

In some embodiments, the completed, signed identity certificate 400 is stored, in step 314, in a special identity certificate store such as 500 in FIG. 5. This store 500 collects the identity certificates 502, 504, 506 created by a single user of the peer device 102. The user's profile is set to refer to the store 500 so that when a call is made to retrieve or create an identity and the calling user's context is obtained, the corresponding store 500 is opened. The certificate with the appropriate peer name is then quickly found. The identity certificate store 500 is created on a per-user basis because different users of the peer device 102 should not have access to identities created by other users.

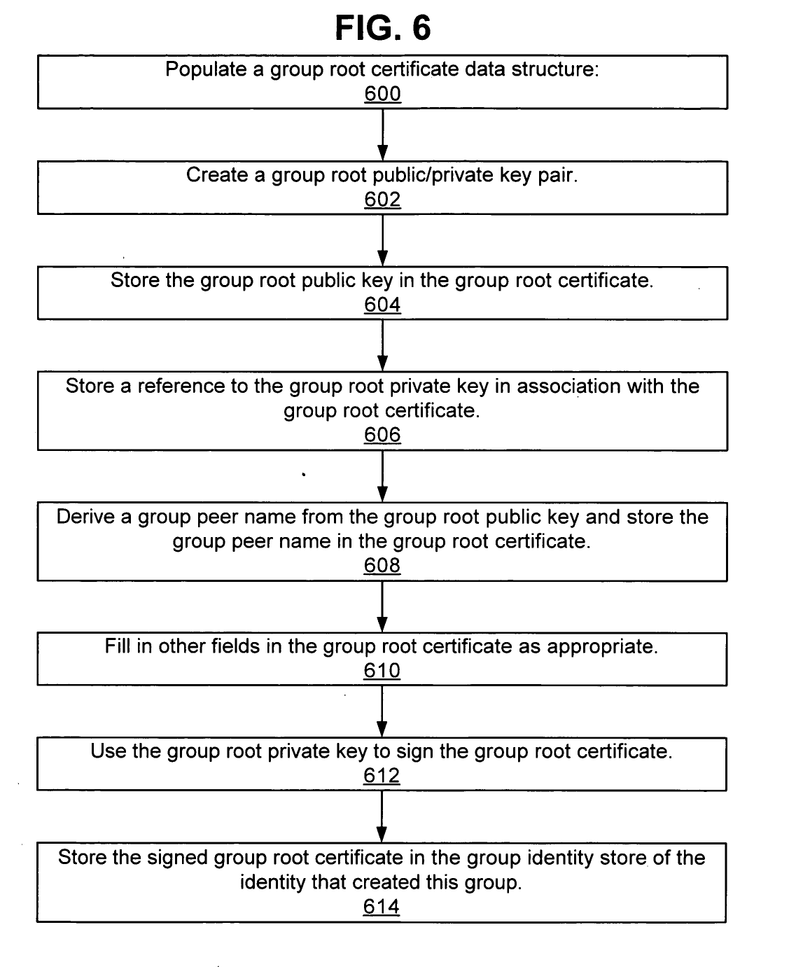

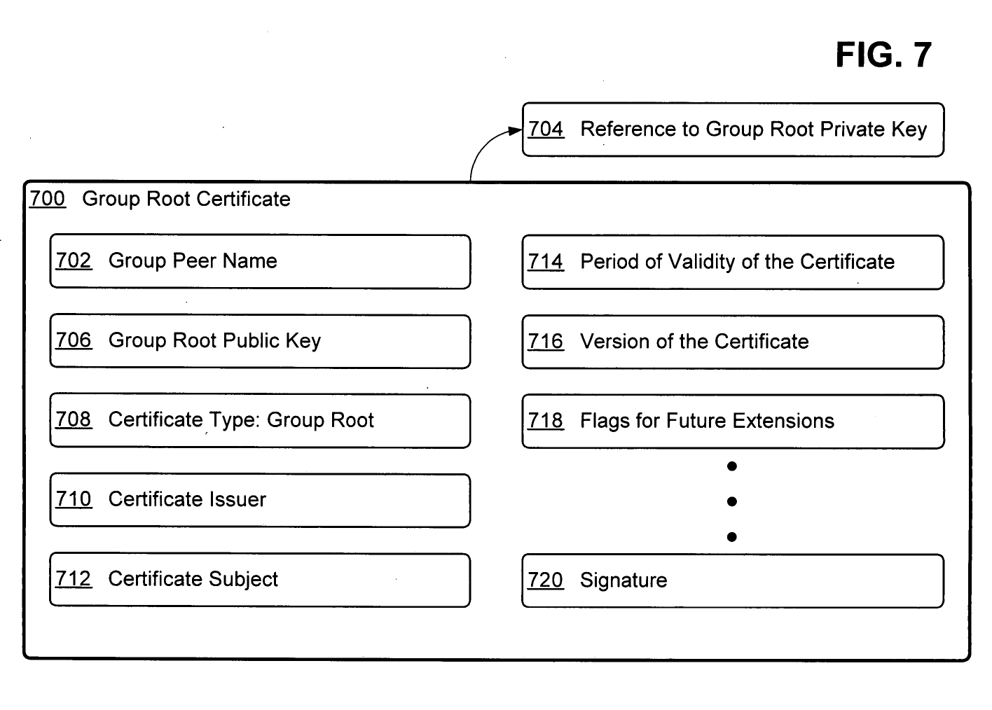

When a peer device creates a new group, it also creates an identity for that group and a group root certificate for that identity. FIGS. 6 and 7 show an exemplary method for creating a group root certificate and an embodiment of the certificate, respectively. As many of the steps and fields are the same as for the identity certificate, only the highlights are discussed here.

Beginning in step 600 of FIG. 6, a group root certificate data structure (700 in FIG. 7) is populated. As with the identity certificate 400, the group root certificate 700 can be an X.509 certificate, but need not be. A unique public/private encryption key pair is created in step 602, and the public key is used to derive a group peer name (field 702) in step 608. Unlike with the identity certificate 400, a copy of the group root certificate 700 can be shared with other peer devices. (See the discussion of FIGS. 11a, 11b, and 11c below.) Thus it is even more important that the private key not be stored within the group root certificate 700 itself. Just as with the identify certificate 400, a reference to the private key is stored in association with the group root certificate 700 (step 606, field 704).

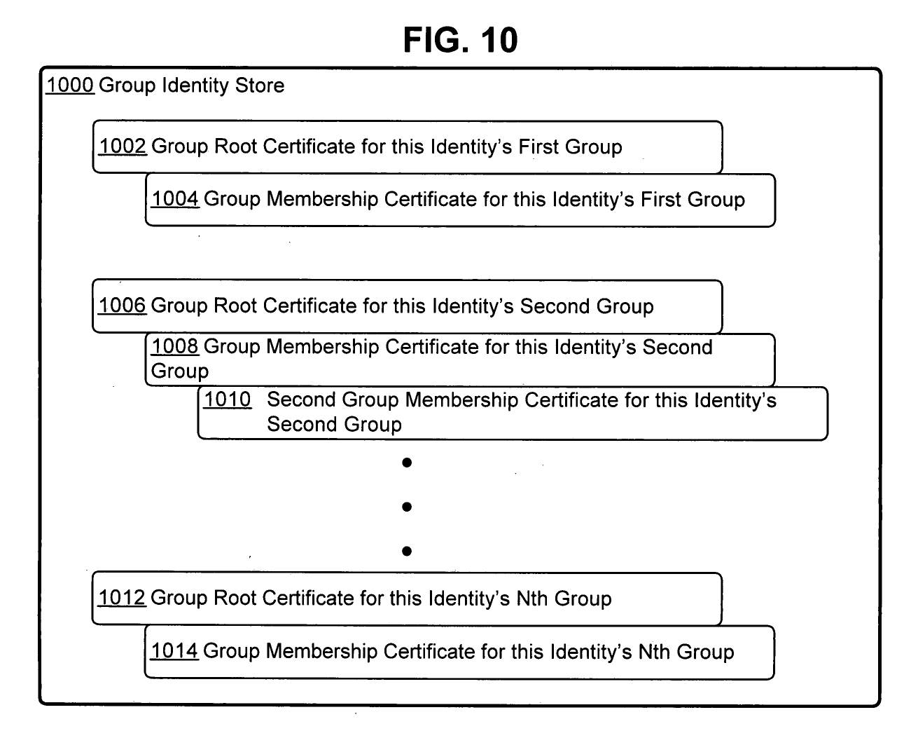

Other fields of the group root certificate 700 are then populated, and the certificate 700 is signed in step 612 using the private key created in step 602. The final step 614 of FIG. 6, storing the completed, signed group root certificate 700, is discussed below in reference to FIG. 10.

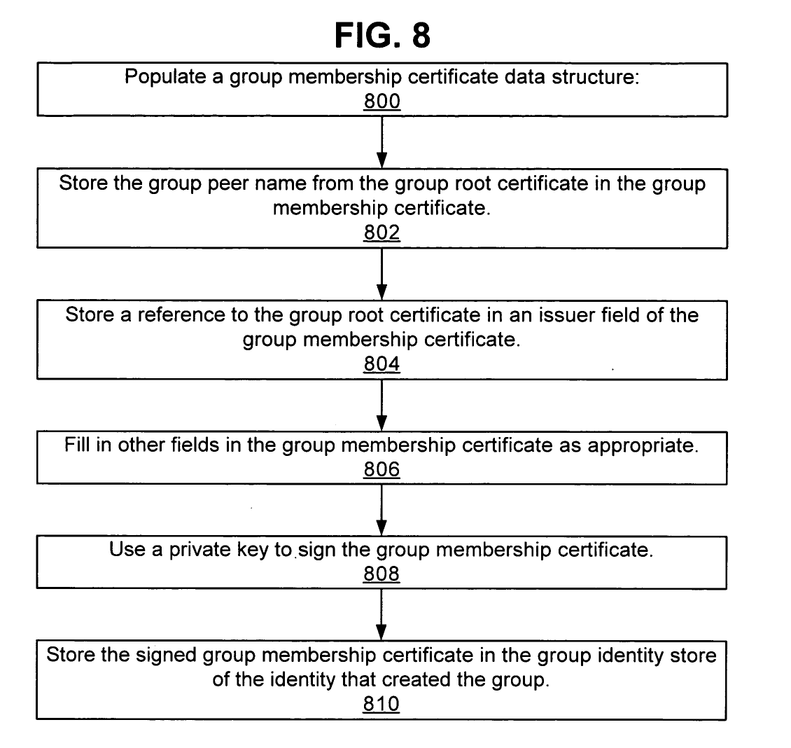

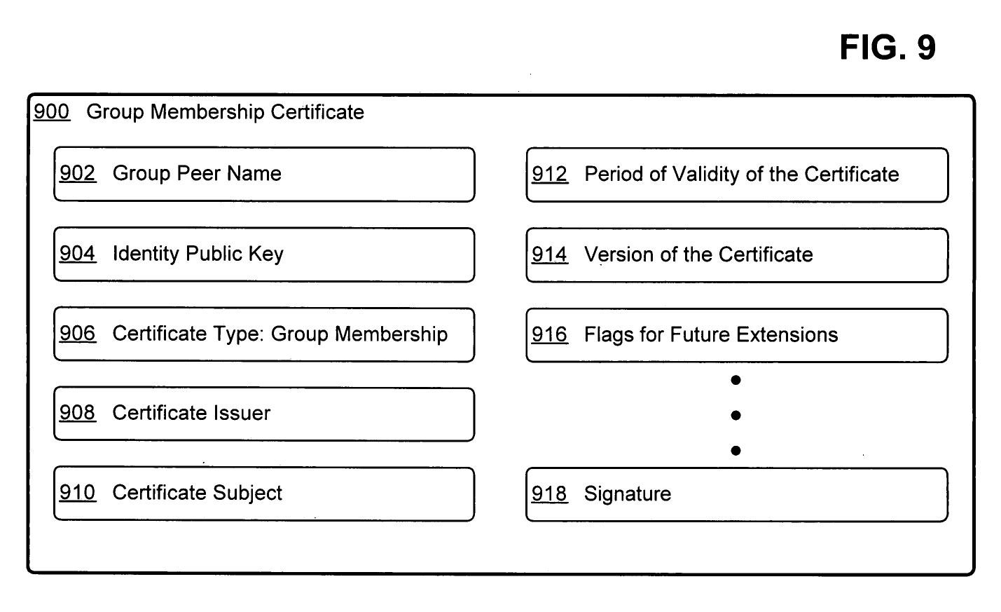

In some scenarios, the creator of a group needs yet another certificate before it is ready to invite other peer devices to join the group. This is the group membership certificate, created by a method such as that exemplified in FIG. 8 and embodied in a structure such as that shown in FIG. 9. In step 802 of FIG. 8, the group peer name is copied from field 702 of the group root certificate 700 and placed in field 902 of the group membership certificate (900 of FIG. 9). In its issuer field 908, the group membership certificate 900 refers back to the group's group root certificate 700 (step 804). After populating other fields, if necessary, the group membership certificate 900 is signed in step 808 using a private key. The group creator knows the private key stored in association with the group root certificate 700 and can use that key. Others can create a new public/private key pair for signing. If signed by the group root private key, this signature ensures that only the creator of the group, and therefore the holder of the group root private key, could have created this group membership certificate 900. The situation in which a peer other than the group creator creates a group membership certificate 900 is discussed below in reference to FIGS. 11a, 11b, and 11c.

In the final step 810 of FIG. 8, as in the final step 614 of FIG. 6, the certificate is stored in a group identity store. FIG. 10 presents an exemplary store 1000. Unlike the identity certificate store 500 which is created on a per-user basis, the group identity store 1000 is created on a per-identity basis, the identity being the creator of the groups in the store 1000. To facilitate access to these stores, of which a given user can have many, a group identity store 1000 is given a unique name based on the unique peer identity of the groups' creator. As illustrated in FIG. 10, the group identity store 1000 has one group root certificate 1002, 1006, 1012 for each group created by the peer identity. “Chained” to each group root certificate (using the fields described above in reference to FIGS. 8 and 9) are the group membership certificates 1004, 1008, 1010, and 1014 for each group. (As discussed below in reference to FIGS. 11a, 11b, and 11c, there can be multiple group membership certificates chained to a group root certificate.) Based on the unique peer identity of the groups' creator, this storage schema facilitates the creation, listing, retrieval, and manipulation of the group certificates.

Having presented the identity, group root, and group membership certificates and techniques for storing them, the discussion now presents an example of how certificates are used. In this example, the peer device 102 creates a new group, say the group 114 of FIG. 1. As described above in reference to FIGS. 6 and 7, the peer device 102 first creates a group root certificate 700 to represent the identity of the new group 114. Next, the peer device 102 creates a group membership certificate 900 and chains it to the new group root certificate 700 (described above in reference to FIGS. 8 and 9). When the peer device 102 wishes to invite another peer, say the peer 108 of FIG. 1, to the join the new group 114, the peer device 102 sends a copy of the group root certificate 700 and a copy of the group membership certificate 900 to the invitee peer device 108. The copy of the group root certificate 700 does not contain a reference to the group private key (field 704).

Upon receipt of the copies of the group root certificate 700 and the group membership certificate 900, the invitee peer device 108 can use the methods of FIGS. 11a, 11b, and 11c to check the validity of the certificates. Of course, if the invitee peer 108 is not interested in joining the new group 114, it is free to discard the received certificates without verifying them.

The invitee peer device 108 receives the certificates in steps 1100 and 1102 of FIG. 11a. Note that step 1102 allows for the possibility of a certificate chain with more than one group membership certificate 900. The reason for the presence of multiple group membership certificates 900 in the chain is discussed below. The methods of FIGS. 11a, 11b, and 11c apply in any case.

In step 1104 of FIG. 11a, the group root certificate 700 is checked. In sub-step 1106 of step 1104, the group peer name (field 702) is checked to make sure that it was properly derived from the group root public key (field 706). (See the discussion of FIG. 6's step 608 above.) The signature of the group root certificate 700 is checked in step 1108. Other tests are, of course, possible, depending upon which fields are present in the group root certificate 700. For example, the validity period (field 714) can be checked to see if the certificate 700 is outdated. Other verification tests can include: Did the issuer of this certificate have sufficient authority to issue this certificate? Are the classifiers valid (see the discussion of step 308 of FIG. 3 above)? Are other rules of this security domain followed (e.g., rules about peer-to-peer roles)? If the group root certificate 700 is successfully verified (step 1110), then the group membership certificates 900 are checked beginning in step 1112 of FIG. 11b. Otherwise, the invitation, consisting of the chain of certificates, is discarded in step 1128 of FIG. 11c.

In step 1112, the invitee peer device 108 begins with the group membership certificate 900 that is closest to the group root certificate 700 in the chain. Then in step 1114, the invitee peer 108 attempts to verify that the group membership certificate 900 is properly chained to the certificate before it, whether that certificate is another group membership certificate 900 or the group root certificate 700 at the head of the chain. The group peer name (field 902) of the group membership certificate 900 should match that of the group root certificate 700, and this is checked in step 1116, a sub-step of the multi-part step 1114. If the group membership certificate 900 passes that test, then in step 1118 the issuer peer name (field 908) is checked to see if it refers to the certificate before it (next closer to the group root certificate 700) in the chain. Finally, the group membership certificate 900 should have been signed using the private key associated with the public key in field 904. This is checked, by applying standard techniques to the public key corresponding to that private key, in step 1120 of FIG. 11c. Just as with the group root certificate 700, other tests are possible.

If any of the verification tests fails (step 1122), then the invitation is discarded in step 1128 of FIG. 11c. If, on the other hand, the group membership certificate 900 is successfully verified, then step 1114 is repeated for additional group membership certificates 900 in the chain, if any (step 1124). When the last (or only) group membership certificate 900 is successfully verified, then the invitee peer 108 is free, in step 1126, to accept the invitation and to join the group 114.

It was mentioned above that the chain of certificates could contain more than one group membership certificate 900. To illustrate this, assume that the peer device 108 accepted the above invitation and has joined the group 114. If the peer 108 now wishes to extend the group 114 to include the peer 110, it could, of course, ask the group creator 102 to invite the peer 110. Some groups are indeed set up this way in which only the group creator is allowed to invite others to join the group. Instead, however, the group may be set up so that the peer 108 is allowed to issue invitations. To do so, it creates a new group membership certificate 900 and adds it to the certificate chain that it received from the group creator 102. The new certificate 900 is linked using the same mechanisms described above in reference to FIGS. 8 and 9. The peer 108 creates a new public/private key pair, adds the new public key to the certificate that was at the end of the chain, and uses the new private key to sign the new group membership certificate 900. In this manner, the certificate chain can grow without having to always return to the group creator.

In view of the many possible embodiments to which the principles of the present invention may be applied, it should be recognized that the embodiments described herein with respect to the drawing figures are meant to be illustrative only and should not be taken as limiting the scope of the invention. For example, those of skill in the art will recognize that the illustrated structural embodiments and methods can be altered without departing from the spirit of the invention. Other possible implementation details are described in the following Appendix. Although the invention is described in terms of software modules or components, those skilled in the art will recognize that such may be equivalently replaced by hardware components. Therefore, the invention as described herein contemplates all such embodiments as may come within the scope of the following claims and equivalents thereof.

### APPENDIX: Identity Manager Implementation Design

1. Introduction and Feature Summary

The identity manager is a component that is responsible for managing peer identities. In particular, the following functions are performed by the identity manager:
(i) create, delete, and enumerate identities;
(ii) create certificates;
(iii) create, delete, and enumerate groups of which the identity is a member; and
(iv) manage certificates associated with the identity or with the groups of which the identity is a member.
   2. Abbreviations

The following is a short list of abbreviations used in this document.
IDC: IDentity Certificate, a self-signed certificate representing an identity.
GMC: Group Membership Certificate, a certificate proving that a particular identity is a member of the group.
GRC: Group Root Certificate, a self-signed certificate representing a group
   3. API Assumptions
   3.1 Standard Error Codes

All error codes returned by all functions are formatted as HRESULT. The following is a list of currently used error codes. Some of the error codes below are not HRESULTs, but they are converted to HRESULT using the HRESULT_FROM_WIN32 macro when returned.

| Error | Definition |
|---|---|
| S_OK | Operation completed successfully. |
| E_OUTOFMEMORY | Not enough memory to complete |
| | the operation. Because all output |
| | buffers are allocated by the caller, |
| | the error can be returned only |
| | when allocation of some |
| | internal data structures fails. |
| E_INVALIDARG | One of the input parameters |
| | is not valid. |
| ERROR_INVALID_HANDLE | Handle passed as an input |
| | parameter is not valid. |
| ERROR_NOT_FOUND | Requested object cannot be found. |
| ERROR_BAD_FORMAT | One of the input binary |
| | parameters is not properly |
| | formatted. |
| ERROR_ALREADY_EXISTS | An object already exists. |
| ERROR_HANDLE_DISK_FULL | Drive volume is full. |
| ERROR_SHARING_VIOLATION | Operation requires exclusive |
| | access to the object. |
| E_FAIL | Unexpected error. |

3.2 Memory Allocations

All output parameters returned by any of the functions in the API are allocated by the callee and should be freed by the caller using one of the provided routines.

E_OUTOFMEMORY can be returned if the allocation of output parameters or of any of the internal data structures fails. E_OUTOFMEMORY indicates that the machine is running low on virtual memory and that some applications should be closed. Every caller should be able to handle this error from any of the functions specified below.

4. Internal Architecture

4.1 Reference Counting

Every object represented by a handle is an object with a reference counter. When an object is created for the first time, and a handle to it is returned, the reference counter of the object is set to one. All subsequent retrievals of that handle internally increment the object's reference counter by one. When the handle to the object is no longer needed, it must be released, which decrements the reference counter. When the reference counter reaches zero, the object is destroyed, and all memory allocated for the object is freed.

If an object is permanently deleted, then its reference counter is decremented. If the counter reaches zero, then the object is deleted from the disk, and the in-memory copy is destroyed; otherwise, the object is marked as deleted, and all further operations on the object, except for release operations, return errors. When the reference counter on the deleted object reaches zero, the object is not only destroyed, and its memory freed, but its on-disk representation is also deleted.

4.2 Implementation Handles

All handles given out by the identity manager API are RPC context handles. There are multiple benefits to using RPC handles:
(i) RPC context handles are associated with the RPC session so that they cannot be used outside of the RPC session and therefore cannot be stolen;
(ii) RPC context handles have an automatic cleanup mechanism for use when a client.process dies and does not free all of its handles; and
(iii) The same RPC context handle cannot be released twice.
   4.3 Creating Identities

Any NT user is allowed to create identities using the PeerIdentityCreate( ) function. Every identity is associated with a particular NT user account, such that only the given NT user is allowed to access this identity. Even though there is no hard limit on the number of identities that can be created by the same NT user, a reasonable limit would be 300 identities per user. Performance issues might arise if there are more than 300 identities created by a single NT user.

An identity is represented by a handle to the identity object. When the identity is no longer needed, the identity should be released by calling PeerIdentityRelease( ) which releases the reference to the in-memory identity object. The identity can be permanently destroyed and deleted from disk by calling PeerIdentityDelete( ).

4.4 Storing Identities

An identity is represented by a set of certificates, which set contains all necessary information for the identity to be functional. Storing an identity means storing all the certificates related to that identity: the IDC, GMCs, and GRCs.

For every NT user there is a file-based certificate store which contains all IDCs for all the identities owned by that NT user. For every identity, there is an identity group store which contains all certificates related to that identity.

Whenever identities are enumerated or retrieved, the identity manager chooses among the IDCs that are available in the user identity store. The identity certificate store is a file which has an ACL which prevents other NT users from accessing the certificate store (file-level protection is applicable only to the files stored on the NTFS partition; no file-level protection in the case of FAT). The ACL contains only one ACE that grants full access to the NT user that created this identity. The SID of the owning NT user is set as the owner's SID on the file's security descriptor. Certificate stores for the specified NT user are located in the “PeerToPeer” directory under the Application Data directory in the user profile. The Application Data directory can be located in different places on different machines so it has to be retrieved by calling SHGetFolderPatho and specifying CSIDL_APPDATA as the folder ID (normally, C:\Documents and Settings\username\Application Data). Every call to the identity manager is done under the NT user context (RpcImpersonateClient( ) enables the identity manager to impersonate the caller over RPC), and therefore the correct files can always be located.

Once an identity certificate is retrieved, the group identity store can be easily located: It should always be placed in the same directory as the identity certificate store, and the name of the file should be an identity peer named in human-readable form. The group identity store has the same file-level protection as the identity certificate store.

When an identity is retrieved or created, a caller's NT user context is obtained, and the corresponding identity certificate store is opened. If an identity is retrieved, then the identity manager can enumerate all identity certificates in the store and can find the one with the particular peer name. If an identity is created, then a new IDC is added to the identity store along with the associated group identity store.

All modifications to the identity (e.g., setting new certificates during the certificate renewal process) are committed to the disk immediately so that the identity does not have to be explicitly persisted on the disk.

4.5 Importing and Exporting Identities

Since an identity can be fully represented by the set of certificates associated with it, import and export of the identity is equivalent to import and export of all identity certificates. During export, an in-memory certificate store is created, and shortcuts to all relevant certificates are created in that store. After that, PFXExportCertStore( ) is called so that all of these certificates, along with the associated private keys, are transferred into the in-memory binary blob and encrypted with some other key. Similarly, during identity import, PFXImportCertStore( ) is invoked which transfers all the certificates from the binary blob to the in-memory certificate store. After that, all certificates are inspected, and relevant certificates are moved to the permanent identity certificate stores.

4.6 Implementing Handles

The identity manager exposes handles to identity objects as opaque values. Since they are opaque, they can be copied to the client application address space unmodified (as opposed to real NT handles).

Internally, every handle can be type-cast to an object of a particular class. Every object has its object type set at the time when the object is created and invalidated when the object is destroyed. Object type provides information in order to cast the handle to an object of a particular type, as well as provide some level of protection from handles to objects that were destroyed.

The identity API provides protection from dereferencing invalid memory. The easiest way to protect against that is to invoke exception handling when verifying the validity of a pointer. The same technique is used to check the validity of the handles provided by an application.

4.7 Managing Keys

The identity manager does not perform any special management for the identity or group private keys. The identity manager uses Windows-default CSP to store private keys. The keys are natively associated with the certificates (IDC or GRC). This allows them to be preserved during import and export operations.

When a new identity or group is created, the identity manager is responsible for generating a new public/private key pair 1024 bits in length and for associating the key pair with the IDC. Keys are generated using the standard CryptGenKey( ) function with a default cryptographic service provider and with the key being an AT_KEYEXCHANGE key. (AT_SIGNATURE can be used only for signing, but these identity keys are needed both for signing and for establishment of a secure channel.) The default CSP in Windows XP is a “Microsoft Strong Cryptographic Service Provider” with a default RSA key length of 1024 bits.

4.8 Generating Peer Names

The identity manager is responsible for generating peer names. When a new identity is created, a new public/private key pair is generated for the identity (unless an existing key pair is provided), and the peer name is generated out of it. The peer name is an SHAl hash of the public key, converted into text form, plus a classifier appended to it after the dot. Here is a simple formula on how a peer name is derived from a public key: peemame=hex_string(sha1(public key))+“.classifier”.

A peer name by itself can not be verified, as its relation to ‘some’ public key cannot be calculated. Peer names corresponding to the identities existing on the local machine can be mapped to the identity object by calling PeerldentityByPeerName( ). The same call with the same peer name will fail with any other machine where the appropriate identity does not exist.

4.9 Certificate Cleanup

The identity manager does not own any threads and therefore does not perform any background certificate cleanup for expired or revoked certificates. The only time when the identity manager performs any kind of cleanup is when a certificate is read by the identity manager into memory. If it is an IDC, then the identity manager simply renews the certificate and returns a fresh version of the certificate. If it is a GMC, then the identity manager deletes the certificate from the disk. The rest of the certificate cleanup is performed by the group security manager component.

4.10 Threading Model

The identity manager is a component that does not initiate any activity on its own (callbacks, timers, background processing), so it does not own any threads. The identity manager code is always executed on the caller thread (on the client side) or on the RPC thread (on the service side).

4.11 Synchronization

The Identity API supports multiple applications accessing the same identity simultaneously. Multiple client stubs can bind to the identity manger LPC port and invoke methods on the same identity object. Calls to the Identity API are serialized at the level of the identity object. Every identity object has its own critical section, so that calls into the same identity object can be serialized.

5. Formats

5.1 Mapping Peer Certificates to X.509v3 Certificate Format

| X509.v3 Field | GMC | IDC | GRC |
|---|---|---|---|
| Version | CERT_V3 | | |
| Serial Number | Serial number | | |
| Signature Algorithm | szOID_RSA_SHA1RSA | | |
| Issuer | Friendly name | Friendly name | Friendly |
| | of issuer | of identity | name of |
| | | | group |
| Not Before | Start of validity period | | |
| Not After | End of validity period | | |
| Subject | Friendly name | Friendly name | Friendly |
| | of group | of identity | name of |
| | member | | group |
| Subject Public Key Info | Public key of | Public key of | Public key of |
| | group member | identity | group |
| Issuer Unique ID | Not used | | |
| Subject Unique ID | | | |
| Extension: | CERT_TYPE_{—} | CERT_TYPE_{—} | CERT_TYPE_{—} |
| szOID_PEERNET_CERT_TYPE | GMC | IDC | GRC |
| Extension: | Peer name of | Peer name of | Peer name of |
| szOID_SUBJECT_ALT_NAME | group member | identity | group |
| Extension: | Peer name of | | |
| szOID_ISSUER_ALT_NAME | issuer | | |
| Extension: | Peer name of | | Peer name of |
| szOID_PEERNET_GROUPING_PEERNAME | group | | group |
| Extension: | | | |
| szOID_PEERNET_IDENTITY_ISSUER_KEY | | | |
| Extension: | | Identity flags | |
| szOID_PEERNET_IDENTITY_FLAGS | | (optional) | |
| Extension: | Membership | | Group flags |
| szOID_PEERNET_GROUPING_FLAGS | flags (optional) | | (optional) |
| Extension: | List of roles of | | |
| szOID_PEERNET_GROUPING_ROLES | group member | | |
| Extension: | List of | | |
| szOID_PEERNET_CLASSIFIERS | classifiers | | |
| Extension: | Authentication | | |
| szOID_PEERNET_GROUPING_AUTHDATA | data (binary) | | |
| Extension: | | | |
| szOID_PEERNET_IDENTITY_CROSS_SIGN | | | |

5.2 Certificate Encoding Format

Even though every certificate is an ASN.1-encoded binary blob which can be sent on the wire, for sending multiple certificates some extra formatting could be needed (total number of certificates, total blob size, etc.). To avoid inventing new formats, a common way to encode multiple certificates is used: All certificates are copied to the in-memory certificate store, and then this certificate store is saved into another memory block using ASN.1 encoding. The identity manager uses the optimized version of this procedure and, instead of copying the certificates into the temporary store, creates shortcuts for these certificates.

This format is used by the identity manager when the PeerIdentityGetCert( ) function is called, regardless of whether a certificate or a certificate chain is returned.

5.3 Group and Identity Import and Export Formats

Even though a group or an identity is represented by a set of relevant certificates, the certificate encoding format mentioned above is not used because, during import and export of the certificates, associated private keys might also need to be imported or exported. PFX (Personal Information Exchange) format is used to import and export identities or groups. Similar to the certificate-encoding scheme, all certificates relevant to a group or an identity are placed into the in-memory certificate store after which PFXExportCertStore( ) is called. During the import, the same operation can be reversed by calling PFXImportCertStore( ).

This format is used when PeerIdentityExport( ) and PeerIdentityExportGroup( ) are called.

5.4 XML Identity Information Format

In order for an identity to join a group, it needs to export information about itself and pass that information to the existing group members who would be able to issue an invitation. In essence, all necessary information about the identity is encapsulated in the IDC. In order to adhere to modern data exchange standards, this binary blob is encoded and presented as an XML fragment that has the following structure:

<PEERIDENTITYINFO VERSION = “1.0”>

<IDC xmlns:dt = “urn:schemas-microsoft-com:datatypes” dt:dt =
“bin.base64”>

base64 encoded / PKCS7 encoded IDC

</IDC>

</PEERIDENTITYINFO>

This XML fragment is generated by the PeerIdentityGetXMLInfo( ) API. Applications are not allowed to add tags within the PEERIDENTITYINFO tag or to modify this XML fragment in any way. Applications are allowed to incorporate this XML fragment into other XML documents, but they are obligated to strip out all their XML before passing this into the PeerIdentityCreateXMLInvitation( ) API.
5.5 XML Invitation Format

An invitation to join a group is nothing more than a GMC chain for the new group member and is represented as an XML fragment with the following structure:

<PEERINVITATION VERSION = “1.0”>

<CLOUDNAME>

UTF-8 encoded unicode name of the cloud

</CLOUDNAME>
<GMC xmlns:dt = “urn:schemas-microsoft-com:datatypes” dt:dt =
“bin.base64”>

base64 encoded / PKCS7 encoded GMC chain

</GMC>

</PEERINVITATION>

This XML fragment is generated by the PeerIdentityCreateXMLInvitation( ). Applications are not allowed to add tags within the PEERINVITATION tag or to modify this XML fragment in any way. Applications are allowed to incorporate this XML fragment into other XML documents, but they are obligated to strip out all their XML before passing this into the PeerIdentitySetXMLInvitation( ) or PeerIdentityParseXMLInvitation( ) API.

1. A computer-readable medium containing an identity certificate data structure, the identity certificate data structure comprising:
a first data field containing data representing an identity peer name;
a second data field containing data representing an identity public key, the identity public key and an identity private key forming a public/private key pair;
a third data field containing data representing a certificate type, the certificate type indicating an identity certificate; and
a fourth data field containing data representing a signature of the identity certificate, the signature derived, at least in part, from the identity private key.

2. The identity certificate data structure of claim 1 wherein the identity certificate data structure is an X.509 certificate.

3. The identity certificate data structure of claim 2 wherein the first data field is a subject alternative name field of the X.509 certificate.

4. The identity certificate data structure of claim 2 wherein the third data field is an extension property field of the X.509 certificate.

5. The identity certificate data structure of claim 1 wherein the identity peer name in the first data field is globally unique.

6. The identity certificate data structure of claim 1 wherein the identity peer name in the first data field is derived, at least in part, from the identity public key in the second data field.

7. The identity certificate data structure of claim 6 wherein the identity peer name in the first data field is derived, at least in part, from a hash of the identity public key in the second data field.

8. The identity certificate data structure of claim 1 wherein the identity private key is stored in a Cryptographic Service Provider container.

9. The identity certificate data structure of claim 1 further comprising:
a fifth data field containing data representing an issuer of the identity certificate; and
a sixth data field containing data representing a subject of the identity certificate, wherein the issuer and the subject of the identity certificate are the same.

10. The identity certificate data structure of claim 1 further comprising:
a fifth data field containing data representing a period of validity of the identity certificate.

11. The identity certificate data structure of claim 1 further comprising:
a fifth data field containing data representing a version of the identity certificate.

12. A computer-readable medium containing a group root certificate data structure, the group root certificate data structure comprising:
a first data field containing data representing a group peer name;
a second data field containing data representing a group root public key;
a third data field containing data representing a certificate type, the certificate type indicating a group root certificate; and
a fourth data field containing data representing a signature of the group root certificate, the signature derived, at least in part, from a group root private key, the group root private key and the group root public key in the second data field forming a public/private key pair.

13. The group root certificate data structure of claim 12 wherein the group root certificate data structure is an X.509 certificate.

14. The group root certificate data structure of claim 13 wherein the first data field is a subject alternative name field of the X.509 certificate.

15. The group root certificate data structure of claim 13 wherein the third data field is an extension property field of the X.509 certificate.

16. The group root certificate data structure of claim 12 wherein the group peer name in the first data field is globally unique.

17. The group root certificate data structure of claim 12 wherein the group peer name in the first data field is derived, at least in part, from the group root public key in the second data field.

18. The group root data structure of claim 17 wherein the group peer name in the first data field is derived, at least in part, from a hash of the group root public key in the second data field.

19. The group root certificate data structure of claim 12 further comprising:
a fifth data field containing data representing an issuer of the group root certificate; and
a sixth data field containing data representing a subject of the group root certificate, wherein the issuer and the subject of the group root certificate are the same.

20. The group root certificate data structure of claim 12 further comprising:
a fifth data field containing data representing a period of validity of the group root certificate.

21. The group root certificate data structure of claim 12 further comprising:
a fifth data field containing data representing a version of the group root certificate.

22. A computer-readable medium containing a group membership certificate data structure, the group membership certificate data structure comprising:
a first data field containing data representing a group peer name;
a second data field containing data representing an issuer peer name;
a third data field containing data representing a subject peer name;
a fourth data field containing data representing a certificate type, the certificate type indicating a group membership certificate; and
a fifth data field containing data representing a signature of the group membership certificate.

23. The group membership certificate data structure of claim 22 wherein the group membership certificate data structure is an X.509 certificate.

24. The group membership certificate data structure of claim 23 wherein the first data field is an extension property field of the X.509 certificate.

25. The group membership data structure of claim 23 wherein the second data field is an issuer alternative name field of the X.509 certificate.

26. The group membership data structure of claim 23 wherein the third data field is a subject alternative name field of the X.509 certificate.

27. The group membership data structure of claim 22 wherein the group peer name in the first data field is globally unique.

28. The group membership data structure of claim 22 wherein the issuer peer name in the second data field is a reference to a certificate selected from the group consisting of: a group root certificate and a group membership certificate.

29. The group membership certificate data structure of claim 22 further comprising:
a sixth data field containing data representing a period of validity of the group membership certificate.

30. The group membership certificate data structure of claim 22 further comprising:
a sixth data field containing data representing a version of the group membership certificate.

31. The group membership certificate data structure of claim 22 further comprising:
a sixth data field containing data representing a public key, the public key and a private key forming a public/private key pair.

32. A computer-readable medium containing a group certificate chain data structure, the group certificate chain data structure comprising:
a first data field containing data representing a group root certificate, the group root certificate comprising:
a second data field containing data representing a group peer name;
a third data field containing data representing a group root public key;
a fourth data field containing data representing a certificate type, the certificate type indicating a group root certificate; and
a fifth data field containing data representing a signature of the group root certificate, the signature derived, at least in part, from a group root private key, the group root private key and the group root public key in the third data field forming a public/private key pair; and
a sixth data field containing data representing a group membership certificate, the group membership certificate comprising:
a. seventh data field containing data representing a group peer name, the group peer name in the seventh data field being the same as the group peer name in the second data field in the group root certificate;
an eighth data field containing data representing an issuer peer name, the issuer peer name in the eighth data field being a reference to the group root certificate in the first data field;
a ninth data field containing data representing a subject peer name;
a tenth data field containing data representing a certificate type, the certificate type indicating a group membership certificate; and
an eleventh data field containing data representing a signature of the group membership certificate.

33. The group certificate chain data structure of claim 32 wherein the group root certificate and the group membership certificate are X.509 certificates.

34. The group certificate chain data structure of claim 32 wherein the group membership certificate in the sixth data field further comprises:
a twelfth data field containing data representing a public key, the key and a private key forming a public/private key pair.

35. The group certificate chain data structure of claim 34 further comprising:
a thirteenth data field containing data representing a second group membership certificate, the second group membership certificate comprising:
a fourteenth data field containing data representing a group peer name, the group peer name in the fourteenth data field being the same as the group peer name in the second data field in the group root certificate;
a fifteenth data field containing data representing an issuer peer name, the issuer peer name in the fifteenth data field being a reference to the group membership certificate in the sixth data field;
a sixteenth data field containing data representing a subject peer name;
a seventeenth data field containing data representing a certificate type, the certificate type indicating a group membership certificate; and
an eighteenth data field containing data representing a signature of the second group membership certificate.
